(19) United States
(12) Patent Application Publication
(10) Pub. No.: US 2010/0230917 A1
(43) Pub. Date: Sep. 16, 2010

(54) TRANSPORTABLE DISPLAY CART

(76) Inventor: Geoffrey Lambert, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/402,373

(22) Filed: Mar. 11, 2009

(51) Int. Cl. B62B 1/00; A47B 37/00; G09F 11/00

(52) U.S. Cl. 280/47.11; 108/50.11; 40/1

(57) ABSTRACT

A transportable display cart includes a chassis with ground engaging wheels and an upper body removably supported by the chassis. The upper body has a first side portion and a second side portion hingedly connected in a clamshell arrangement such that the first and second side portions pivot between a closed position and an open position. Each of the first side portion and second side portion have a flat side panel such that in the open position, the first and second side portions form a flat surface. There is a transport connector on the chassis for supporting the upper body in the closed position for transport or storage. There is a display connector on the chassis for supporting the upper body in the open position or in a position intermediate the closed position and the open position.

### FIELD

A transportable display carts having multiple modes.

### BACKGROUND

Canadian patent application no. (not yet known) filed Jul. 20, 2007 entitled “Portable Shelter” describes a shelter that may be pulled by a bicycle.

### SUMMARY

According to an aspect, there is provided a transportable display cart, comprising a chassis with ground engaging wheels and an upper body removably supported by the chassis. The upper body comprises a first side portion and a second side portion hingedly connected in a clamshell arrangement such that the first and second side portions pivot between a closed position and an open position. Each of the first side portion and second side portion have a flat side panel such that in the open position, the first and second side portions form a flat surface. There is a transport connector on the chassis for supporting the upper body in the closed position for transport or storage. There is a display connector on the chassis for supporting the upper body in the open position or in a position intermediate the closed position and the open position.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of the transportable display cart.

FIG. 2 is an exploded perspective view of the transportable display cart.

FIG. 3 is a perspective view of the upper body in a partially open position.

FIG. 4 is a perspective view of the transportable display cart in an advertising display mode.

FIG. 5 through 7 are perspective views of the transportable display cart in alternative advertising display modes.

FIG. 8 is a perspective view of the transportable display cart in a table display mode.

FIG. 9 is a top plan view of the transportable display cart in a cot mode.

FIG. 10 is a side elevation view of an alternative transportable display cart in a display mode.

FIG. 11 is a side elevation view an alternative transportable display cart in an alternative display mode.

FIG. 12 is a front elevation view of an alternative transportable display cart in the display mode of FIG. 11.

FIG. 13 is a side elevation view an alternative transportable display cart in the alternative display mode of FIG. 10.

FIG. 14 is an exploded front elevation view of an alternative transportable display cart.

FIG. 15 is an exploded front elevation view of an alternative transportable display cart in a table display mode.

FIG. 16 is a perspective view of an alternative transportable display cart in a display mode.

### DETAILED DESCRIPTION

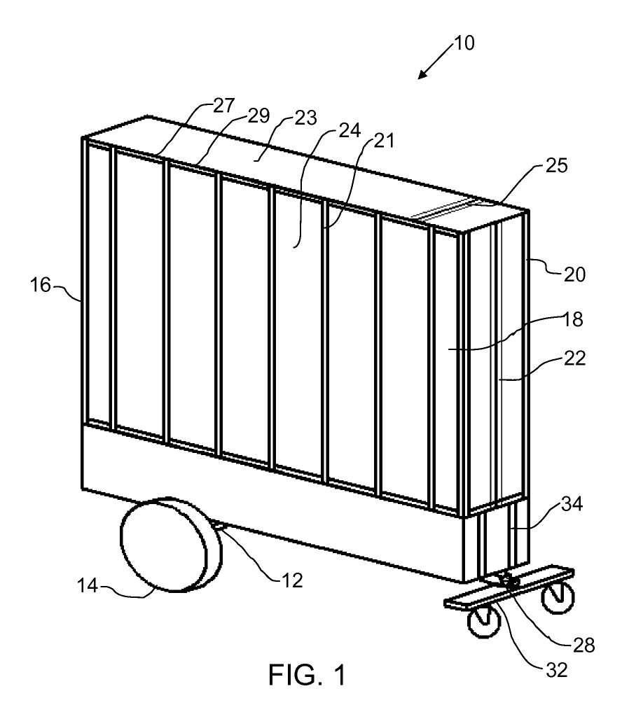

A transportable display cart generally identified by reference numeral 10, will now be described with reference to FIG. 1 through 16.

### Structure and Relationship of Parts:

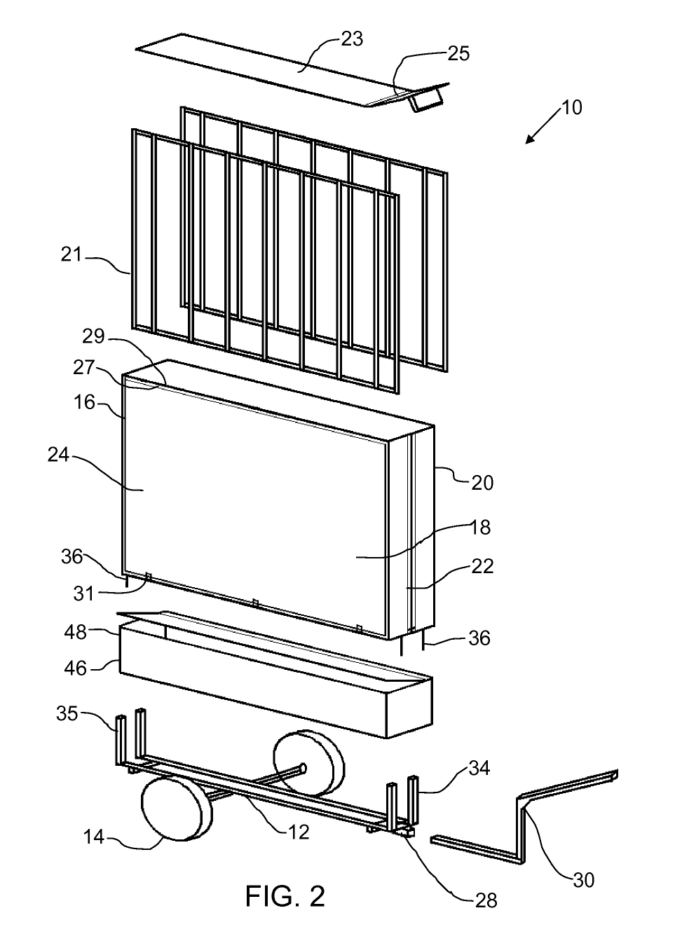

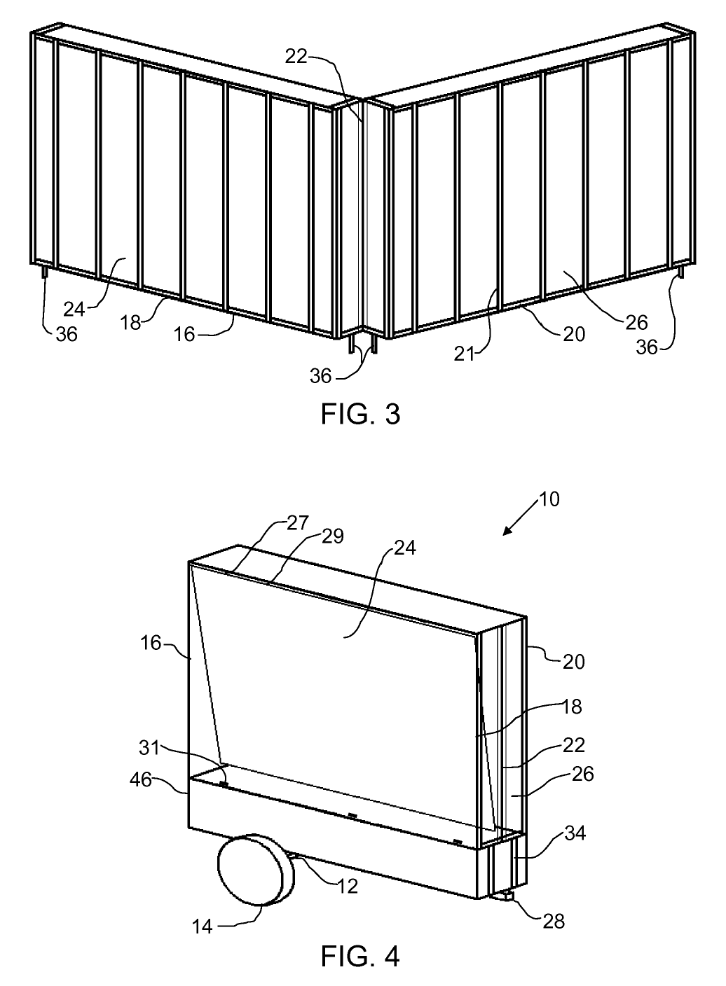

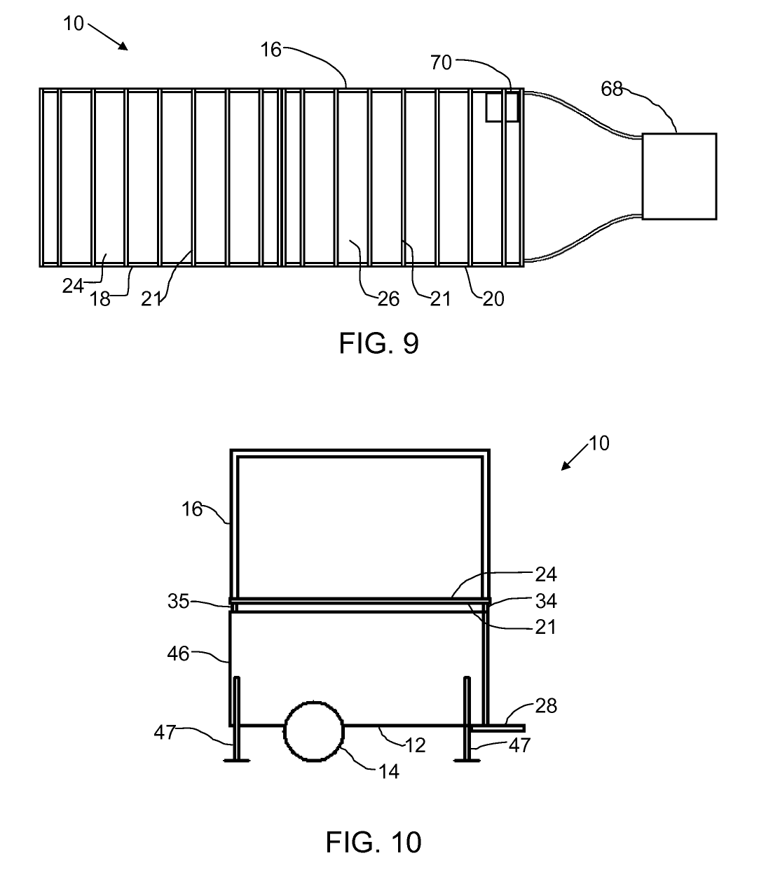

Referring to FIGS. 1 and 2, transportable display cart 10 has a chassis 12 with ground engaging wheels 14. There is an upper body 16 that is removably supported by chassis. Referring to FIG. 3, upper body 16 has a first side portion 18 and a second side portion 20 that are connected by a hinge 22 in a clamshell arrangement. First and second side portions 18 and 20 pivot between a closed position shown in FIG. 1 and an open position shown in FIG. 9 or 14. Referring to FIG. 14, first and second side portions 18 and 20 have a flat side panel 24 and 26, respectively, such that in the open position, first and second side portions 18 and 20 form a flat surface. First and second side portions 18 and 20 also include a fixed or removable support frame 21. Upper body 16 may also have a removable top panel 23 with a hinge 25. In the depicted embodiment, hinge 25 is a vertical hinge, however, it will be understood that hinge 25 may also be horizontal. Side panels 24 and 26 may be removable. Side panels 24 and 26 may be connected to upper body 16 by a hinge 27 along a top edge 29 such that side panels 24 and 26 are permitted to pivot when released on the bottom and sides, such as by releasing tabs 31. Chassis 12 has an attachment 28, which is a section of square tubing as shown that allows either a bicycle attachment 30 to be attached as shown in FIG. 2, or a set of wheels 32 as shown in FIG. 1.

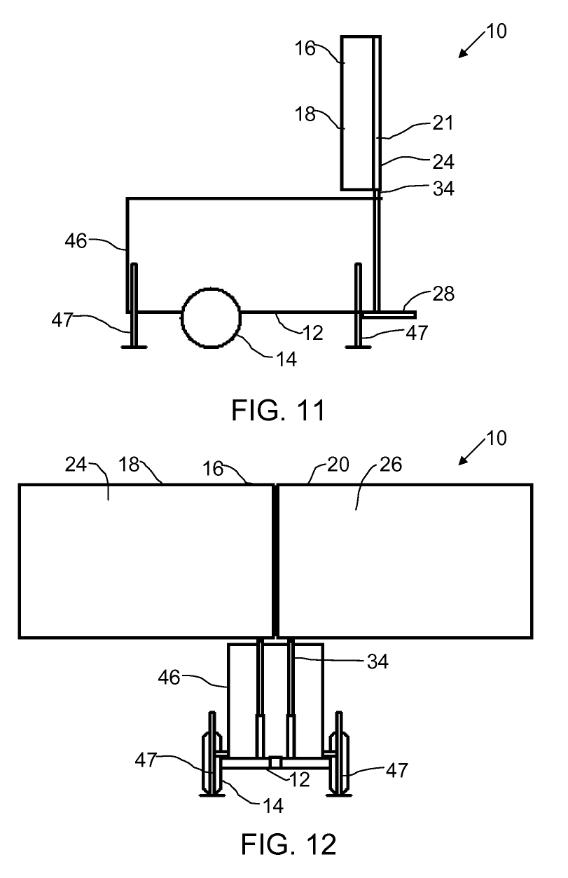

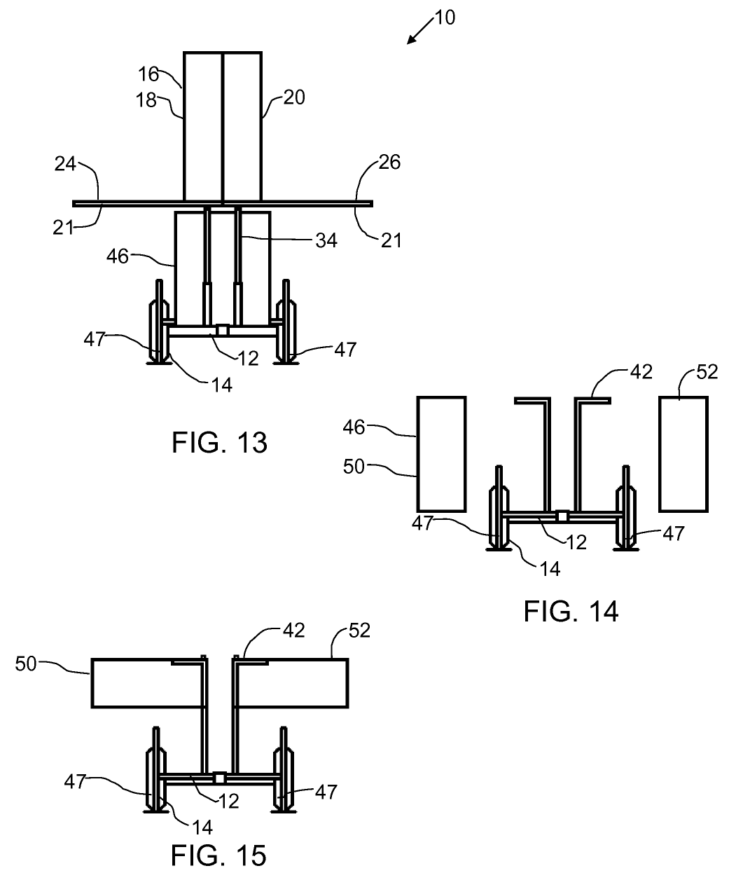

Referring to FIG. 2, there is a transport connector on chassis 12 that supports upper body 16 in the closed position for transport or storage. As shown, the transport connector is a series of female receivers including front transport connectors 34 and rear transport connectors 35 that receive corresponding pins 36 on the bottom of upper body 16. Referring to FIGS. 8 and 11-13, a display connector on chassis 12 is provided for supporting the upper body in the open position. As will be apparent to those of ordinary skill, instead of an open position, it may also be a position intermediate the closed position and the open position (not shown). FIGS. 8 and 11-13 show different types of connectors that may be provided in alternative or in combination. As shown in FIG. 8, the rear transport connectors 35 are also used as display connectors, and front transport connectors 34 may also be used, if desired. Other display connectors 38 may be included that are spaced back from the front transport connectors 34 in the case of display connectors 38. Connectors 34, 35, and 38 used as display connectors may be supplemented by L-shaped supports 42. Referring to FIGS. 11 and 12, connectors 34, 35 or 38 may also be located on the top of, or integrally formed with, a frame 44 used to define a lower body 46. As shown, connectors 34 support upper body 16 such that the first and second side portions 18 and 20 are in a vertical orientation. Referring to FIGS. 10 and 13, connectors 34 and 35 may also allow for a table to be formed by supporting upper body 16 in a horizontal position. In the depicted embodiment, only removable support frames 21 and optionally side panels 24 and 26 are used while the remainder of upper body 16 remains mounted on top of chassis 12, such as to provide advertising. Chassis 12 may have stabilizer legs 47 to stabilize display cart 10.

It will be understood that the number and position of the various connectors will depend on the preferences of the user. For example, the connectors may play a role in mounting both upper and lower bodies 16 and 46. In addition, upper portion 16 may be longer than the lower body 46, in which case more than one set of transport connectors would be needed. Furthermore, the spacing requirements will be different if upper portion 16 is attached to chassis 12 in the display mode based on it length or width.

As mentioned previously, there may also be a lower body 46 supported by chassis 12. Referring to FIG. 2, lower body 46 may be a removable box 48. Referring to FIG. 14, lower body 46 may be a pair of side portions 50 and 52 that attach to a frame 44 to form a lower compartment. In this embodiment, frame 44 may support either upper body 16 in a display position, or, as shown in FIG. 15, side portions 50 and 52 may be removed and supported by frame 44 in a display position. To allow for this, each of the first and second lower portions 50 and 52 are detachable, and have a flat side panel 54 and 56 and connectors, such as holes that allow lower portions 50 and 52 to be pin connected to chassis 12. In a display mode, flat side panels 54 and 56 are supported by chassis 12 via frame 44 in a horizontal orientation to form a table top. Alternatively, lower body 46 may be a clamshell design similar to the design of upper body 16 shown in FIG. 3, although the height may be varied, depending on the preferences of the user. If used for a sleeping surface, this allows an extra wide sleeping surface to be formed by placing the two clamshell structures next to each other in the open position.

Both lower body 46 and upper body 16 may have a structural frame, or constructed from a sufficiently strong material such that a structural frame is not required.

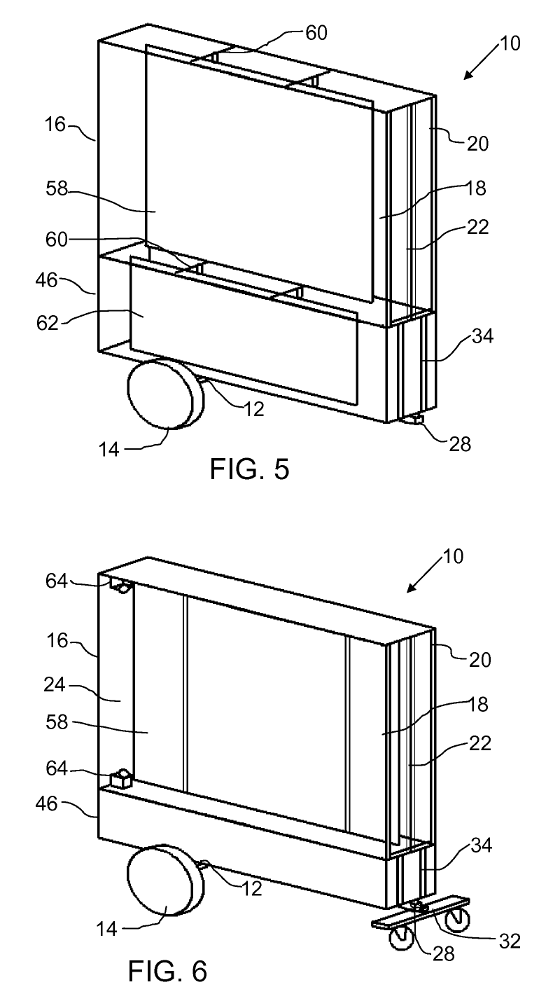

In addition to advertising in the display mode, transport display cart 10 may also be used for advertising in the transport mode. For example, panels 24 and 26 may be advertisements. Alternatively, referring to FIG. 5, side panels 24 and 26 of upper body 16 may be removed, and an advertisement 58 may be hung from structural members 60 in upper body 16. Advertisement 58 would be permitted to swing freely in the event of a wind to prevent damage. Another advertisement 62 may also be hung below upper body 16 as shown, supported by either upper body 16, or lower body 46 in a similar fashion.

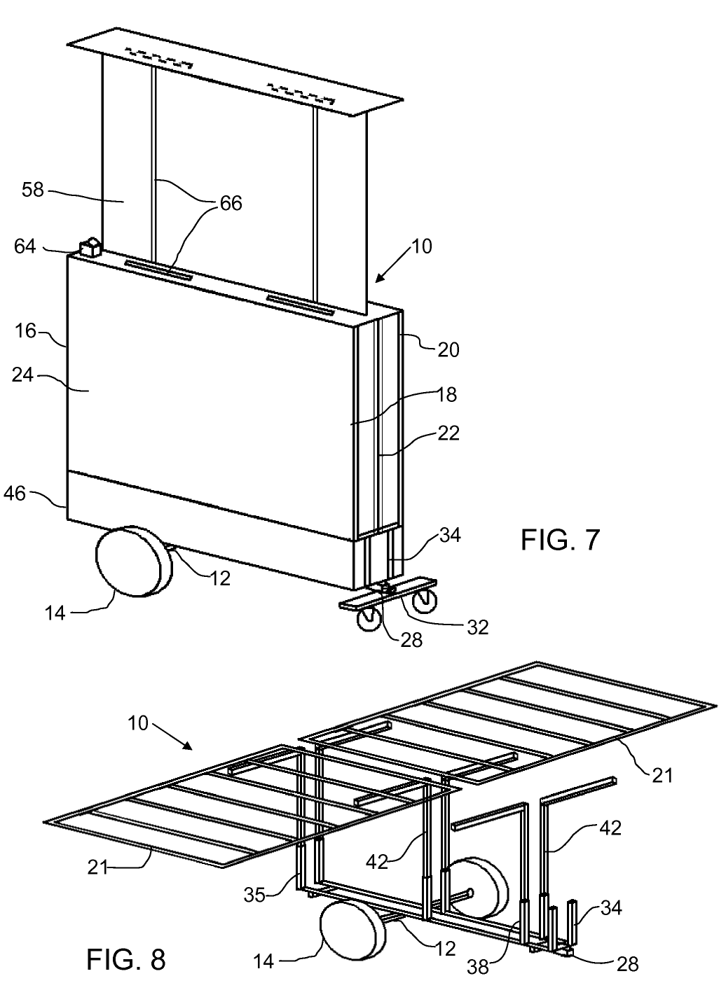

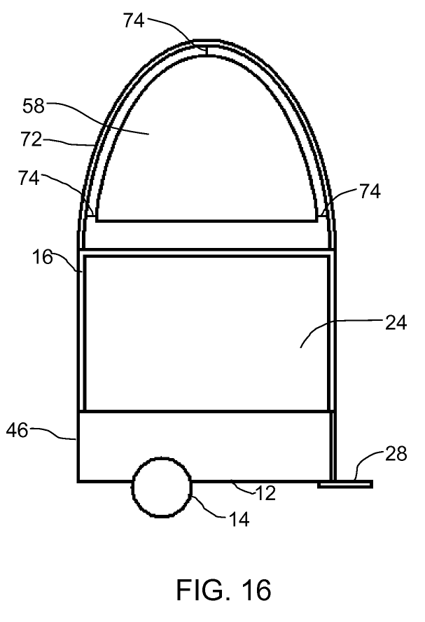

Advertisements 58 and 62 may take various shapes aside from the rectangular shape shown, as will be recognized by those in the art. In another embodiment, referring to FIG. 6, side panels 24 and 26 may be transparent or translucent, with advertisement 58 positioned within upper body 16. Advertisement 58 may be illuminated by a light source 64 positioned within upper body 16. Alternatively, referring to FIG. 7, advertisement 58 may be mounted on top of upper body 16 and supported by a display frame 66 mounted on top of upper body 16 for that purpose. Light source 64 may be positioned on top of upper body 16 to illuminate advertisement 58. Referring to FIG. 2, top panel 23 may also be used as advertising space by rotating it about its hinge 25. Referring to FIG. 16, other attachments may be included to increase advertising space or to advertise in different ways. For example, as shown, a length of flexible plastic 72 is shown that may be extended to form an arch over upper portion 16 from which advertisement 58 may be suspended. Plastic 72 may then be removed or retracted against upper portion 16 when not required. As discussed previously, advertisement 58 may take various shapes, and as shown, may be designed to fit within flexible plastic 72. Advertisement 58 is preferably attached using elastic connectors 74 to reduce wind resistance.

Referring to FIG. 9, upper body 16 may also be used as a horizontal sleeping surface when positioned on the ground in the open position. The sleeping surface is supported by frames 21, which are preferably removable, as shown in FIG. 2. While not shown, a shelter structure may also be provided that attaches to either side of the sleeping surface, either by being attached to the ground, or by providing attachments on either side of the side portions. In the depicted embodiment, supporting frames 21 form a fluid passage for passing heated fluid through the fluid passage. For example, water may be heated by a heater 68, such as an electric, combustion, or solar heater, and heated fluid may be circulated by a pump 70.

### Operation:

As mentioned above, display cart 10 has a transport mode and a display mode. In a preferred embodiment, display cart 10 has multiple display modes, combinations of transport and display modes, and a camping mode.

Referring to FIG. 1, display cart is shown in a transport mode, with wheels 14 mounted to chassis 12, and wheels 32 connected to connector 28. This would be suitable for pushing. Alternatively, referring to FIG. 2, a bicycle attachment 30 may be connected to connector 28 to allow chassis 12 to be pulled by a bicycle. It will be apparent that other attachments may also be used, such as an attachment for connecting to a motorized vehicle such as a golf cart, etc.

In the transport mode, the various components as well as any equipment or objects required by the user may be stored in lower body 46 and possibly upper body 16. Upper body 16 is mounted on chassis 12 by inserting pins 36 into connectors 34 and 35. Lower body 46 is also preferably mounted on chassis 12 using connectors 34, for example, by having them pass through body 46, or by sizing body 46 such that it fits closely within connectors 34.

Referring to FIG. 4, side panels 24 and 26 may be released, such as by rotating tabs 31 to allow side panels 24 and 26 to move in the wind, which provides some protection from cart 10 being upset by wind. One display mode may be achieved by mounting an advertisement 58 on side panel 24.

Referring to FIGS. 4 and 5, one display mode may be achieved by mounting advertisements 58 on upper body 16 and/or lower body 46, such as by attaching them to structural members 60, which also allow advertisements 58 to move in the wind to reduce wind resistance. Referring to FIG. 6, alternatively, upper body 16 may have transparent sides 24 and 26 with advertisement 58 mounted within, or, referring to FIG. 7, structural frame 66 for mounting advertisement 58 thereon. Upper body 16 may also have one or more light sources 64 for illuminating advertisement 58 either within upper body 16 as shown in FIG. 6, or on top as shown in FIG. 7.

In addition to transportable display modes, which are particularly useful for advertising, cart 10 may also be arranged as a display table or advertisement. These modes may be particularly useful for street vendors, etc. Referring to FIG. 8, a table may be formed by inserting L-shaped supports 42 into connectors 35 and 38, and mounting removable frames 21 thereon. While not shown, a flat surface may be provided by laying panels 24 and 26 on top of frames 21. Frames 21 may be mounted by their width as shown or their length, depending on the preference of the user. Referring to FIGS. 10 and 13, cart 10 may be arranged with frames 21 and panels 24 and 26 removed from upper body 12, and mounted on either side to form table tops. Upper body 12 may then be used to hang or display other objects between the tabletops formed by panels 24 and 26 and frames 21. Referring to FIGS. 14 and 15, a tabletop may also be formed by using sides 50 and 52 of lower body 46 in one embodiment. Referring to FIGS. 11 and 12, a fixed advertising surface may be provided by opening upper body 16 and mounting it on chassis 12 using connectors 34 in the open position.

Referring to FIG. 9, cart 10 may also be used to provide a sleeping surface if desired. Upper body 16 is removed from chassis 12, opened, and set onto a flat, horizontal surface. Frames 12 keep the user off the ground, while panels 24 and 26 provide a flat surface. In one embodiment, frames 12 may be made from hollow metal rods, and connected such that they form a fluid path. A heater 68 and pump 70 may be provided to circulate warm fluid under the sleeping surface.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A transportable display cart, comprising:
a chassis with ground engaging wheels;
an upper body removably supported by the chassis, the upper body comprising a first side portion and a second side portion hingedly connected in a clamshell arrangement such that the first and second side portions pivot between a closed position and an open position, each of the first side portion and second side portion having a flat side panel such that in the open position, the first and second side portions form a flat surface;
a transport connector on the chassis for supporting the upper body in the closed position for transport or storage; and
a display connector on the chassis for supporting the upper body in the open position or in a position intermediate the closed position and the open position.

2. The transportable display cart of claim 1, further comprising a lower body supported by the chassis.

3. The transportable display cart of claim 1, wherein the display connector comprises a first part of a two part vertical connector and the upper body comprises a second part of the two part vertical connector, the two part vertical connector supporting the upper body in the display mode.

4. The transportable display cart of claim 1, wherein the display connector supports the upper body such that the first and second side portions are in a vertical orientation.

5. The transportable display cart of claim 4, further comprising a lower body supported by the chassis comprising a first lower portion and a second lower portion, each of the first and second lower portions being detachable and comprising a flat side panel and a connector for attaching to the chassis, such that in a display mode, the flat side of first and second lower portions are supported by the chassis in a horizontal orientation to form a table top.

6. The transportable display cart of claim 1, wherein the display connector supports the body in a display mode such that the first and second side portions are in a horizontal orientation to form a table.

7. The transportable display cart of claim 1, wherein the chassis comprises an attachment for selectively attaching a bicycle attachment and wheels.

8. The transportable display cart of claim 1, wherein the side panels of the upper body are removable.

9. The transportable display cart of claim 1, wherein the side panels of the upper body are transparent or translucent.

10. The transportable display cart of claim 9, further comprising an advertisement positioned within the upper body.

11. The transportable display cart of claim 10, wherein the upper body comprises a light source to illuminate the advertisement.

12. The transportable display cart of claim 2, wherein at least one of the upper body and the lower portion supports an advertisement.

13. The transportable display cart of claim 12, wherein the advertisement is supported by a display frame mounted on top of the upper body.

14. The transportable display cart of claim 13, wherein the upper body comprises a light source to illuminate the advertisement.

15. The transportable display cart of claim 1, wherein the side panels are connected to the upper body by a hinge along a top edge such that the side panels pivot.

16. The transportable display cart of claim 2, wherein the lower body is a removable box.

17. The transportable display cart of claim 1, wherein the upper body has supporting frames supporting each of the side panels.

18. The transportable display cart of claim 17, wherein, in the open position, the first and second side portions form a substantially horizontal sleeping surface supported by the supporting frames.

19. The transportable display cart of claim 18, wherein the supporting frames form a fluid passage for passing heated fluid through the fluid passage.

20. The transportable display cart of claim 17, wherein the supporting frames are removable.

21. The transportable display cart of claim 1, further comprising a camping mode where the upper body is removed from the chassis and pivoted to the open position.
